(19) United States
(12) Patent Application Publication
(10) Pub. No.: US 2013/0222338 A1
(43) Pub. Date: Aug. 29, 2013

(54) APPARATUS AND METHOD FOR PROCESSING A PLURALITY OF TYPES OF TOUCH INPUTS

(71) Applicant: Pantech Co., Ltd., (US)

(72) Inventors: Yeongdong Gim, Seoul (KR); Gie II Lee, Seoul (KR)

(73) Assignee: Pantech Co., Ltd., Seoul (KR)

(21) Appl. No.: 13/742,670

(22) Filed: Jan. 16, 2013

(30) Foreign Application Priority Data
Feb. 29, 2012 (KR) 10-2012-0021427

(51) Int. Cl. G06F 3/041

(52) U.S. Cl. CPC G06F 3/041
USPC 345/174; 345/173

(57) ABSTRACT

An apparatus includes a touch sensing unit configured to receive a first-type touch input in a first mode, the first-type touch input being not processed in a second mode dedicated for a second-type touch input, and a controller configured to determine whether the first mode is operated, and to process an operation in the first mode according to the first-type touch input. A method for processing a plurality of touch input types includes receiving a touch input, determining a type of the touch input from a plurality of touch input types including a first-type touch input and a second-type touch input, and, in response to a determination that the touch input corresponds to the first-type touch input, processing the touch input if the touch input corresponds to a defined input pattern or the touch input is received in a first mode for processing the first-type touch input.

### CROSS-REFERENCE TO RELATED APPLICATIONS

This application claims priority from and the benefit under 35 U.S.C. §119(a) of Korean Patent Application No. 10-2012-0021427, filed on Feb. 29, 2012, which is herein incorporated by reference for all purposes as if fully set forth herein.

### BACKGROUND

1. Field

The present disclosure relates to a user interface providing apparatus and method, and more particularly, to an apparatus and method for processing a plurality of types of touch inputs.

2. Discussion of the Background

Generally, a touch screen provides a display device designed such that, when a user directly touches a screen using a finger or a pen shaped touch pen or the like, a mobile terminal recognizes a contact point to execute a command or to move a position of a cursor.

The touch screen may be classified into various types, such as a resistive type (decompression type), an optical type, an electrostatic capacitive type (electrostatic type), an ultrasonic type, and a pressure type, according to implementation needs and operation methods.

A touch screen mounted on a mobile phone, a smart phone, a tablet PC, and the like, may be classified into the resistive type (decompression type) and the electrostatic capacitive type (electrostatic type) in general.

Among them, the electrostatic capacitive type (electrostatic type) includes a touch panel, a controller, and a device driver. When contact occurs between a user's finger and the touch panel, the touch panel determines whether a contact occurs, detects an input coordinate or the like, and transmits an analog signal to the controller. The controller converts the transmitted s signal into a digital signal, and transmits the digital signal to the device driver.

The controller determines the validity of the input value, that is, the input value is caused by an actual touch, noise, or an undesirable touch input, determines the signal conversion, and transmits the information to the device driver.

The device driver provides calculation results to a higher layer, such as a platform and an application program, on the basis of the signal received from the controller, and periodically transmits a command to the controller to keep an accurate operation of the touch panel.

The touch panel receives a capacitive input generated or affected by various reasons and magnitudes, such as a battery of the device, an LCD, Wi-Fi communication, the other device around the device, humidity, temperature, and grip of the device by the user, as well as the touch input from the user.

The input value other than the direct touch of the user may be referred to as a noise throughout the specification; however, some other inputs may be referred to as a noise or a noise input. As a method of discriminating or filtering the noise, specific threshold values (a noise threshold value, a touch sensing threshold value, and the like) may be set for the input electrostatic capacitance, only an input having a magnitude larger than or equal to the touch sensing threshold value may be processed as a valid value (a valid touch input), and a value less than the touch sensing threshold value may be determined to be as a noise input.

Further, conventional electrostatic capacitive touch screens may be operated only by a direct touch of a user, and thus a user interface may be limited to certain aspects.

### SUMMARY

Exemplary embodiments of the present invention provide an apparatus and method for providing a user interface to utilize a peripheral touch input and/or a noise input. A noise value of a touch sensor may be used to implement a user interface.

Additional features of the invention will be set forth in the description which follows, and in part will be apparent from the description, or may be learned by practice of the invention.

An exemplary embodiment of the present invention provides an apparatus, including: a touch sensing unit configured to receive a first-type touch input in a first mode, the first-type touch input being not processed in a second mode dedicated for a second-type touch input; and a controller configured to determine whether the first mode is operated, and to process an operation in the first mode according to the first-type touch input.

An exemplary embodiment of the present invention provides an apparatus, including: a touch sensing unit including a first area to receive a first touch input, wherein at least a portion of the first area corresponding to an area for gripping the apparatus; and a controller configured to determine a grip type of the apparatus according to the first touch input, and to provide a user interface based on the determined grip type.

An exemplary embodiment of the present invention provides a method for processing a plurality of types of touch inputs, including: receiving a touch input; determining a type of the touch input from a plurality of touch input types including a first-type touch input and a second-type touch input; and in response to a determination that the touch input corresponds to the first-type touch input, processing the touch input if the touch input corresponds to a defined input pattern or the touch input is received in a first mode for processing the first-type touch input.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a schematic configuration of an apparatus to provide a user interface based on a touch screen according to an exemplary embodiment of the present invention.

FIG. 2 is a diagram illustrating a user interface setting area of a touch panel according to an exemplary embodiment of the present invention.

FIG. 3 is a diagram illustrating a process for state switching and mode switching according to an exemplary embodiment of the present invention.

FIG. 4A and FIG. 4B are diagrams illustrating an example of analyzing and recognizing an input pattern of a user according to an exemplary embodiment of the present invention.

FIG. 5A and FIG. 5B are diagrams illustrating an example of analyzing and recognizing an input pattern of a user according to according to an exemplary embodiment of the present invention.

FIG. 6, FIG. 7, and FIG. 8 are diagrams illustrating an example of an operation performed based on a pattern recognized according to an exemplary embodiment of the present invention.

FIG. 9 and FIG. 10 are flowcharts illustrating a user interface providing method based on a touch screen according to an exemplary embodiment of the present invention.

FIG. 11 and FIG. 12 are flowcharts illustrating a user interface providing method based on a touch screen according to an exemplary embodiment of the present invention.

### DETAILED DESCRIPTION OF THE ILLUSTRATED EMBODIMENTS

Hereinafter, a user interface providing apparatus and method based on a touch screen will be described in detail with reference to the accompanying drawings.

According to aspects of the present invention, an additional user interface for a user by utilizing a noise that may be intentionally generated by the user. As described above, a mode of sensing a touch by filtering the noise, that is, a mode of processing only a direct touch to a touch panel area or a touch causing a value larger than a threshold as an input may be referred to as a normal mode. A mode of utilizing a valid noise input including a touch reflecting user's intention, e.g., a mode of processing a valid noise generated by a touch or motion for an area other than the touch panel area as an input may be referred to as a noise mode. In the normal mode, the device may detect and utilize a touch input using a threshold value set to process a sensed touch having a sensed value larger than equal to the threshold as an input and/or using a touch input interface that disregards a touch input generated in a peripheral area of the device. In the noise mode, the device may detect and utilize a noise using a threshold value set to process an input other than a normal touch having a sensed value larger than equal to the threshold of the normal mode. That is, for a noise mode, a threshold value may be set to be relatively lower than the threshold value of the normal mode to utilize more noise touch inputs to provide an interface. Further, in the noise mode, a peripheral touch input interface may be activated to recognize and use a touch input generated on a peripheral area of the device.

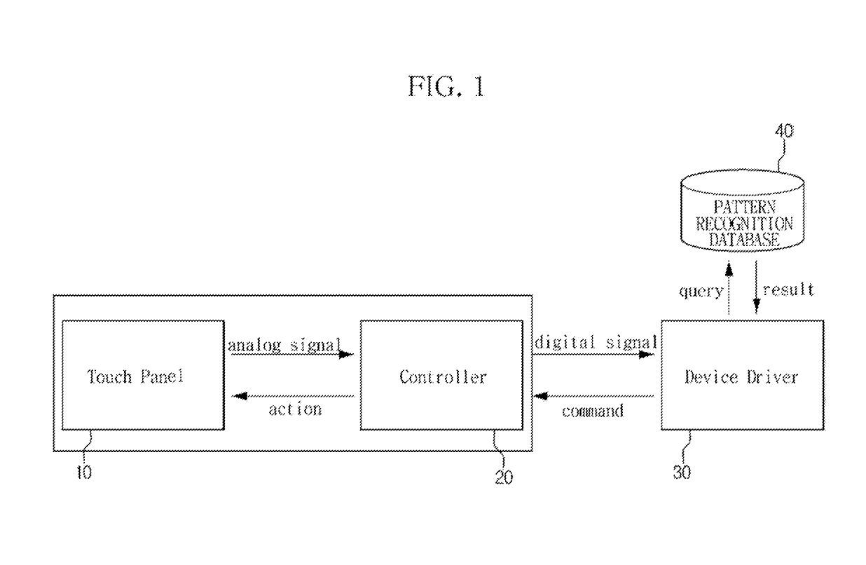

FIG. 1 is a diagram illustrating a schematic configuration of an apparatus to provide a user interface based on a touch screen according to an exemplary embodiment of the present invention.

As shown in FIG. 1, a device includes a touch panel 10, a controller 20, a device driver 30, and a pattern database 40. A touch panel 10 may sense a touch input, via, e.g., a capacitive touch input interface, generated by an approach of an object, e.g., a finger in proximity of the touch panel 10, and/or a contact of the object to generate an analog touch signal representing a coordinate value for a touched area, and transmit the analog coordinate signal to a controller 20. The object may be a recognizable object when located in proximity to a touch panel or contacted the touch panel, and may include a user's finger, an electrostatic touch pen, and the like. The touch panel 10 may be layered with display panel to implement a touch panel display. However, the touch sensing interface may not be limited to the touch panel 10. For example, a touch sensing unit (not shown) including one or more touch sensing portions at which a user's hand may touch when gripping the device.

The controller 20 may convert the analog coordinate signal received from the touch panel 10 into a digital coordinate signal, and transmit the digital coordinate signal to a device driver 30.

The controller 20 may control the touch sensing threshold value and the noise threshold value according to a threshold control command of the device driver 30, and determine validity of the input value received from the touch panel 10 on the basis of the adjusted threshold values.

The pattern recognition database 40 may store input pattern information for recognizing the input pattern of the user in the noise mode.

The input pattern information stored in the pattern recognition database 40 may include input pattern information capable of recognizing a grip type of the device, input pattern information capable of recognizing motion of a finger, input pattern information capable of recognizing a drag motion, input pattern information capable of recognizing a motion of covering the touch screen, input pattern information of recognizing a finger motion of the user, or the like.

When the power is provided to the touch screen, the device driver 30 may initiate the noise mode if the noise mode is set to a default mode, and determine whether to switch from the noise mode to the normal mode and, if the device is switched to the normal mode, whether to switch from the normal mode to the noise mode. When the mode switching is determined, the setting for switching to the mode is performed, the controller 20 may adjust threshold value for valid input determination according to a given mode, and the mode switching may be performed. The adjustment of the threshold value may include a conversion, or a correction of a given threshold value into another threshold value.

If the noise mode is set to the default mode, the grip type of the device of the user may be analyzed, recognized, and/or utilized after the touch screen is turned on with the device gripped by a user.

As described above, the noise mode may be set as a default mode, but is not limited as such. For example, the normal mode or other modes may be set as a default mode.

The device driver 30 may analyze the input pattern of the user in cooperation with the pattern recognition database 40, and determine whether to switch from the noise mode to the normal mode or to switch from the normal mode to the noise mode according to the analyzed result. Although the controller 20 and the device driver 30 will be described separately for description purposes, the device driver 30 may be included in the controller 20 and the controller 20 and the device driver 30 may be implemented by a hardware device, which includes one or more processors.

The threshold value to distinguish between a valid touch input and an invalid touch input, such as a noise touch input, may be determined based on one or more parameters or criteria. For example, an intensity of a touch input may be measured and converted to a digital value. If the intensity of the touch input is less than a first threshold value, the touch input may be determined as a noise input. Further, if the touch area of a touch input does not fall into a touch range corresponding to a predetermined deviation from an average touch area stored in the pattern recognition database 40, the touch input may be determined as a noise input. Further, if the number of multi-touch points is greater than or equal to a second threshold value, the multi-touch input may be determined as a noise input. The first threshold value and/or the touch range may be set different in different operation modes. For example, the first threshold value may be set lower in the noise mode; the touch range may be set wider in the noise mode; and the second threshold value may be set higher in the noise mode, in comparison with the normal mode. Further, the touch panel may be a pressure sensitive type and may distinguish a valid touch input from noise inputs according to pressure of the touch.

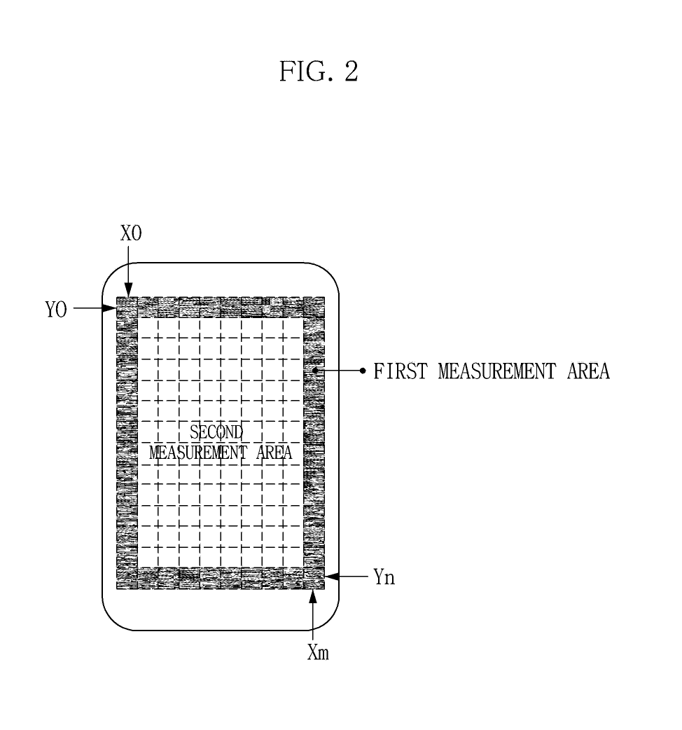

FIG. 2 is a diagram illustrating a user interface setting area of the touch panel according to an exemplary embodiment of the present invention.

A user interface may be additionally provided for the user. For example, a user interface of controlling a screen and/or an application by an operation of attaching and detaching a finger in a state where a user grips the device may be provided. Such as controlling of a screen, an object in the screen, and a volume may be performed by a drag motion provided on an edge of the device by manipulating a finger gripping the peripheral area of the device, and controlling a screen, an application, and/or phone call connection may be performed by a spatial touch and a hand motion, for example.

As described above, the input of the user interface may occur at the outer peripheral part of the touch panel 10. Hereinafter, the user interface provided at the outer peripheral part of a device may be referred to as a peripheral user interface.

As shown in FIG. 2, the outer peripheral area of the touch panel 10 may be set to a first measurement area, and the other area may be set to a second measurement area.

The touch panel 10 of the device shown in FIG. 2 may have (m+1)×(n+1) blocks, the first measurement area may include (X0, Y[0 to n]), (X[0 to m], Y0), (Xm, Y[0 to n]) and (X[0 to m], Yn), and the second measurement area may (X[1 to (m−1)], Y[1 to (n−1)]). However, aspects are not limited as such. The first measurement area may expanded to one or more side surfaces of the device and touch inputs may be received on the side surfaces and sensed by another touch sensor.

During the operation of the noise mode, the device driver 30 may recognize an input pattern of the user. A weight may be applied to the noise input generated in the first measurement area.

The device driver 30 may switch the operation mode from the noise mode to the normal mode on the basis of the input pattern of the user analyzed by retrieving information from the pattern recognition database 40.

The device driver 30 may determine the switching to the normal mode if the user directly touches the second measurement area of FIG. 2 by the touch input provider, such as a finger and an electrostatic touch pen, during the operation of the noise mode.

Further, the device driver 30 may determine the switching to the normal mode if the touch input provider approaches the second measurement area of FIG. 2 within a predetermined distance during the operation of the noise mode.

To switch the operation mode to the normal mode by sensing the approach of the touch input provider, the threshold value for sensing the input value input on the second measurement area may be set to be lower than the threshold value in the method of switching the operation mode to the normal mode by sensing the direct touch.

If a pattern, which is not defined in the pattern recognition database 40, is input during the operation of the noise mode, the device driver 30 may switch the operation mode from the noise mode to the normal mode.

If the operation mode is switched from the noise mode to the normal mode and then a mode switching timer expires (time-out), the device driver 30 may switch the operation mode to the noise mode.

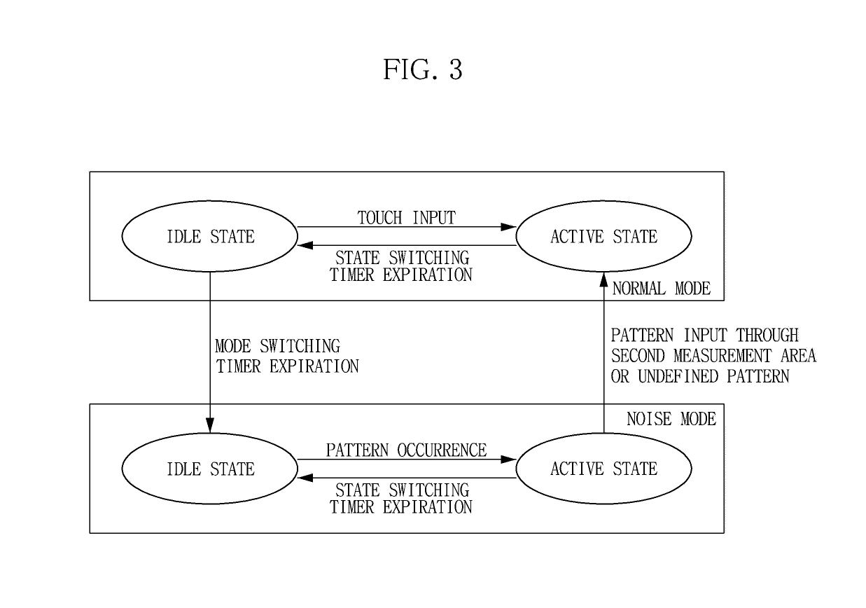

FIG. 3 is a diagram illustrating a process for state switching and mode switching according to an exemplary embodiment of the present invention.

1. State Switching

First, both of the normal mode and the noise mode may support an idle state and an active state. The idle state may refer to a state where there is no touch input of the user for a certain period of time, and may be referred to as a sleep state. The active state may refer to a state where at least one of the touch input of the user occurs in a certain time period, an operation corresponding to the touch input may be performed, and data for the touch input may be acquired from the touch panel 10 at every cycle shorter than that of the idle state. In the idle state, the touch input of the user may be sensed, and thus data for the touch input may be acquired from the touch panel 10. However, a data acquisition cycle may be relatively longer than that of the active state.

In the normal mode, the active state of the device may be switched to the idle state if the state switching timer expires after a touch of the user is completed.

In the idle state, if the touch input of the user occurs, the validity of the user touch may be determined, and then the idle state may be switched to the active state.

In the noise mode, the switching between the idle state and the active state may be performed similarly to the normal mode. That is, if the pattern input of the user occurs in the idle state, the state may be switched to the active state. If the pattern input is completed in the active state and then the pattern input does not occur before the state switching timer expires, the state may be switched to the idle state again.

If the state is switched to the active state according to the pattern input of the user, the device driver 30 may analyze the input pattern of the user based on information stored in the pattern recognition database 40. The information stored in the pattern recognition database 40 may include various pattern types, frequently recognized pattern inputs, or the like. If the analyzed input pattern is the input pattern received through the second measurement area or an input pattern which is not defined, the state may be switched to the active state of the normal mode.

The device driver 30 switched to the active state of the normal mode may perform the input process in a general touch input recognition and operation process.

2. Mode Switching

1) Switching from Normal Mode to Noise Mode

First, in the active state of the normal mode, if the touch input is completed and then the touch input does not occur before the state switching timer expires, the state may be switched to the idle state of the normal mode. After the state is switched to the idle state, if the direct touch input for the second measurement area does not occur before the mode switching timer expires, the state may be switched to the idle state of the noise mode.

In addition, if the mode switching timer expires after the touch input is completed in the active state of the normal mode, the state may be switched to the active state of the noise mode. If the mode switching timer expires after the touch input is completed in the active state of the normal mode, the state may be switched to the idle state of the noise mode. If the pattern input occurs after the state is switched to the idle state of the noise mode, the state may be switched to the active state of the noise mode.

As described above, if the mode is switched from the normal mode to the noise mode, the device driver 30 may perform a setting control for switching from the normal mode to the noise mode, request the controller 20 to adjust the threshold value for the noise mode. The mode may be switched to the noise mode according to the noise mode setting.

The setting for switching to the noise mode from the normal mode may include a setting of an area to be used in the noise mode, a setting of the threshold value to be used in the noise mode, a release of grip and face suppression mode setting, and a setting of the maximum multi-touch point number to be used in the noise mode.

The area to be used in the noise mode may be set to the first measurement area and the second measurement area as shown in FIG. 2, and particularly, a relative weight may be applied to the noise generated in the first measurement area.

The threshold value to be used in the noise mode may be set to a threshold value relatively lower than the threshold value set in the normal mode.

If the threshold value of the noise mode is set to be high, it may be difficult to detect a valid noise input. On the other hand, if the threshold value of the noise mode is set to be low, operation load may increase by detecting many invalid noise inputs. Accordingly, the threshold value of the noise mode may be determined as a proper value according to the usage environment of the device. However, aspects of the present invention are not limited as such. The threshold value may not be changed when the operation mode is switching from the normal mode to the noise mode. For example, in the normal mode, noise inputs may be detected by the device without processing the noise inputs (noise inputs may be ignored and discarded). In another example, undefined noise inputs may be filtered out. In a noise mode, a noise input may be detected and processed according to a defined pattern corresponding to the noise input. The defined pattern may be stored in the pattern database 40.

The maximum number of multi-touch points to be used in the noise mode may be the maximum number of supportable multi-touch points in the device. As the number of supportable multi-touch points increases, the number of applicable patterns geometrically increases, and it may provide an operation of a complex pattern. On the other hand, as the number of supportable multi-touch points decreases, complexity of patterns and the operation load also decreases. The number of multi-touch points may be provided as, e.g., ‘5’, which is the maximum number of fingers gripping the device, and ‘a’ for a motion of the other hand, which does not grip the device, and thus, the maximum number of touch points of ‘(5+a)’ may be provided.

Meanwhile, if the device driver 30 transmits, to the controller 20, a request for adjusting the threshold value to the normal mode threshold value, the current threshold value may be adjusted to the threshold value of the normal mode. Further, if the controller 20 is requested to adjust the threshold value to the noise mode threshold value, the current threshold value may be adjusted to the threshold value of the noise mode.

2) Switching from Noise Mode to Normal Mode

If the input pattern is detected in the active state of the noise mode, the device driver 30 may analyze the input pattern of the user based on information stored in the pattern recognition database 40. If the analyzed input pattern is an input pattern input through the second measurement area or an input pattern, which is not defined in the pattern recognition database 40, the state may be switched to the active state of the normal mode.

In this case, the device driver 30 may perform a setting operation for switching from the noise mode to the normal mode, request the controller 20 adjust the threshold value to the threshold value set for the normal mode, and then switch to the normal mode.

The setting for switching from the noise mode to the normal mode may include a setting of an area to be used in the normal mode, a setting of the threshold value to be used in the normal mode, a setting of a grip and face suppression mode, and a setting of the maximum number of multi-touch points to be used in the noise mode.

The area to be used in the normal mode may be set to an active area where the touch is performed and a clipping area that is an outer peripheral area of the touch panel 10, only the touch input received through the active area may be processed as a valid input, and the value of the input through the clipping area may be ignored.

A touch input, which is not intended by the user in the normal mode, e.g., a touch input generated in the outer peripheral area of the touch panel 10 in the device gripped by the user, and the touch input generated by contact between the face of the user and the front face of the touch panel during a phone call may occurs. As described above, to block an undesirable operation, which may occur by the touch input not intended by the user, the grip and face suppression mode may be set and activated in the normal mode.

If the grip and face suppression mode is set and activated, the touch input in the clipping area that is the outer peripheral area of the touch panel 10 may be ignored according to a grip suppression algorithm. The size of the touch area generated in the active area may be detected according to the face suppression algorithm. If the detected size of the touch area is larger than a preset size of the touch area, the touch input may be recognized as a touch caused by the face and may be ignored.

Meanwhile, the device driver 30 may periodically switch between the normal mode and the noise mode on the basis of a counter setting value.

The device driver 30 may switch the operation mode to the normal mode if the counter value reaches the first counter setting value during the operation of the noise mode, and switch the operation mode to the noise mode if the counter value reaches the second counter setting value during the operation of the normal mode.

The second counter setting value may be set relatively larger than the first counter setting value.

The setting described above is for switching the mode in which a weight is on the normal node, and the setting may cause the device to mainly operate in the normal mode. Further, the user input pattern may be analyzed by switching to the noise mode from the operation of the normal mode.

For example, if it is assumed that the device driver 30 collects an input coordinate from the touch panel ten times per one second, and if the second counter setting value is set to 3 and the first counter setting value is set to 1, the operation mode may be switched from the normal mode to the noise mode once three input coordinates are collected, i.e., once the second counter setting value is met.

Meanwhile, the device driver 30 may analyze the pattern input through the touch panel during the operation of the noise mode based on information stored in the pattern recognition database 40. If the analyzed input pattern is the input pattern input through the second measurement area or the input pattern, which is not defined in the pattern recognition data 40, the mode may be switched to the normal mode as described above. Otherwise, the operation corresponding to the analyzed input pattern may be performed.

Hereinafter, examples of analyzing the input pattern of the user to recognize the pattern will be described.

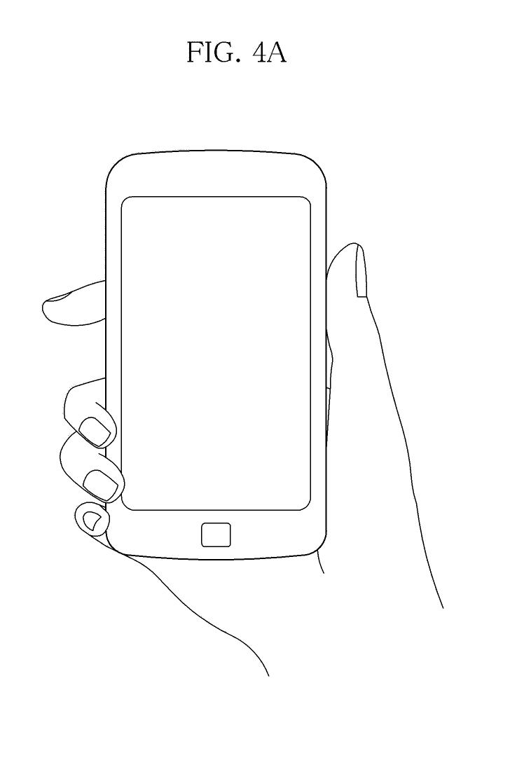

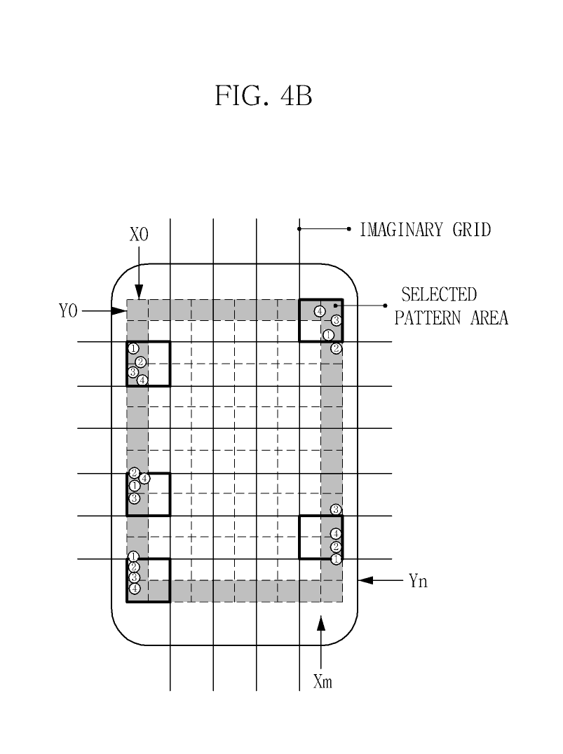

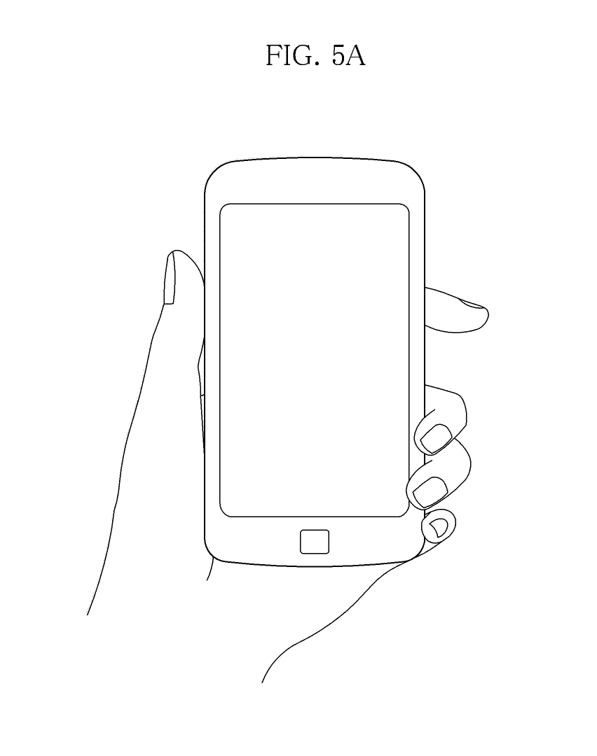

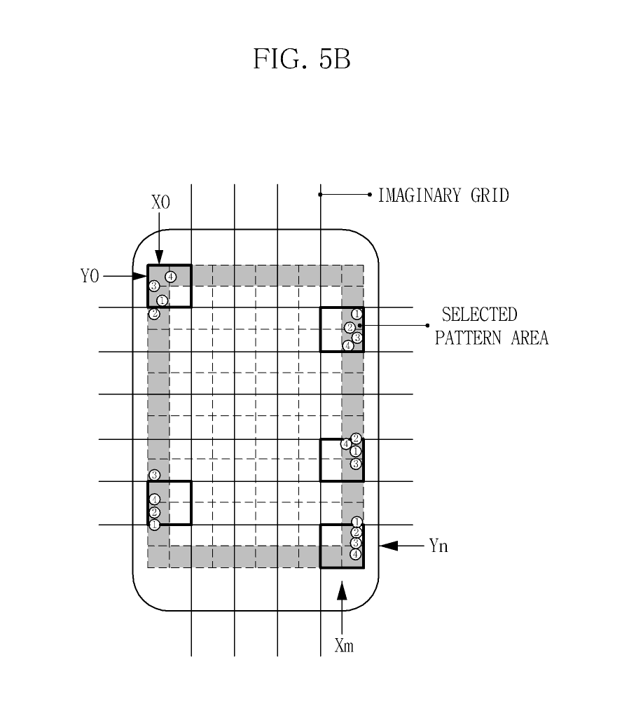

With reference to FIG. 4A, FIG. 4B, FIG. 5A, and FIG. 5B, examples of analyzing the input pattern input received through the first measurement area to recognize the pattern will be described.

If the device driver 30 is switched to the noise mode, the threshold value, the use area, the number of multi-touch points, and the like may be set according to the noise mode.

In the noise mode, the coordinate values generated by noise inputs may be recognized by the device driver 30, and such coordinate values may be changed and applied according to a noise distribution.

As shown in FIG. 4A, if the user grips the device with a right hand, the coordinate values applied to the device driver 30 may be constantly changed according to movements of fingers.

As described above, even when the coordinate values are changed and recognized every time of the input change, a regular pattern may be detected. Specifically, a part where coordinate values equal to or higher than predetermined density are distributed may be determined as one point, and it may be possible to extract a pattern by combination of such points.

The cycle of reading coordinate values of the touch panel 10 may be adjusted through tuning in the active state of the noise mode. As shown in FIG. 4B and FIG. 5B, the touch areas are virtually divided for each block.

Specifically, as shown in FIG. 4A and FIG. 5A, when the user grips the device, distribution of coordinate values equal to or higher than predetermined density occurs in a specific touch area (blocks surrounded by thick lines) as shown in FIG. 4B and FIG. 5B. For example, distribution of coordinate values equal to or higher than predetermined density, such as 1, 2, 3, and 4, occurs in the specific touch area (blocks surrounded by thick lines). It may be possible to detect points for pattern recognition through the distribution of coordinate values generated as described above, and the device driver 30 may extract patterns by combination of such points based on information stored in the pattern recognition database 40. The plurality of blocks in the selected pattern area illustrated in FIG. 4B and FIG. 5B may be referred to as touch input recognition blocks for a noise input. By processing noise touch inputs by the touch input recognition blocks, a pattern of a noise touch input may be recognized with a higher probability based on defined patterns in the pattern recognition database 40.

In the detecting of the points for the pattern recognition, the method of using the coordinate value distribution equal to or higher than predetermined density may be used, and the points may be detected for each block where coordinate values occur. Specifically, in the case of the normal mode, each coordinate value is classified and processed as a separate touch input. However, in the case of the noise mode, values derived from noise inputs may be less important values in comparison with the values derived from valid inputs in the normal mode, and thus a group of the points for each block, which is not each coordinate value, may be processed by each block. Accordingly, if the coordinate values applied to the device driver 30 in the noise mode are coordinate values included in a specific block, it may be possible to detect each block, as a touched area, by recognized points.

Through the process described above, the fingers gripping the device may be processed by points, the combination of such points may be analyzed in cooperation with the pattern recognition database 40 to recognize a grip type of the device (for example, right hand grip, left hand grip, two-hand grip, horizontal grip, vertical grip, and the like). The device driver 30 may optimize and provide disposition of the user interface for the user environment, control screen switching, and/or provide the direction of the user interface operation for the user environment, according to the recognized grip type.

For example, if the left grip is recognized, a lock release direction may be embodied to be achieved from left to right. If the right grip is recognized, the lock release direction is embodied to be achieved from right to left. Further, according to the grip type, e.g., left-handed grip and right-handed grip, a user interface may be reversed symmetrically.

If the horizontal grip is recognized, the screen may be switched to the horizontal screen. If the vertical grip is recognized, the screen may be fixed or switched to the vertical screen. Accordingly, it may be possible to prevent an erroneous operation caused by an acceleration sensor and a gravity sensor (for example, the screen is switched to the horizontal screen when the user lies on user's side and uses the device; the screen switching is not performed when the device is horizontally or vertically rotated in a state where the device is in the horizontal direction, and the like).

When the horizontal grip is recognized while using an application, such as a social network service (SNS) and a mobile instant messenger, a specific function (for example, a message input function) may be driven.

Further, the device driver 30 may recognize an operation of attaching and detaching a finger and an operation of a movement of a finger through the pattern switching in a type where one touch point is removed from the touch and retouched in the same or similar location. Accordingly, the device driver 30 may provide a function to utilize the recognized finger motion as an action of pressing a button, which is not present.

As an example, if the device is gripped by the right hand, when an index finger and a middle finger of the right hand gripping the device are simultaneously placed and removed, a preset function (for example, internet access) may be performed. In this case, the functional operation according to the motion of fingers may be set by the user, or may be defined by a developer of the application.

By the recognized motion of the fingers, various operations may be performed, e.g., the lock release may be performed; the received phone call may be accepted or rejected; and the currently driven application may be ended.

For example, the lock mode may be released by an operation of attaching and detaching the index finger of the hand gripping the device continuously twice.

When there is a received phone call, the received phone call connection may be accepted by an operation of detaching and attaching the index finger of the hand gripping the device and then attaching and detaching the little finger, and the received phone connection may be rejected by an operation of detaching and attaching the thumb.

A recording function may be formed by a specific finger operation (for example, an operation of detaching and attaching an index finger of the hand gripping the device once) during the phone call.

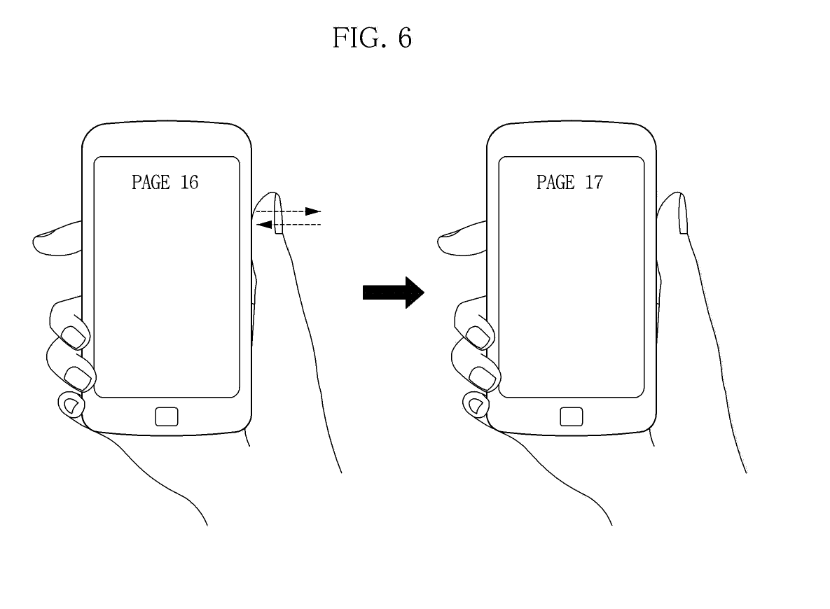

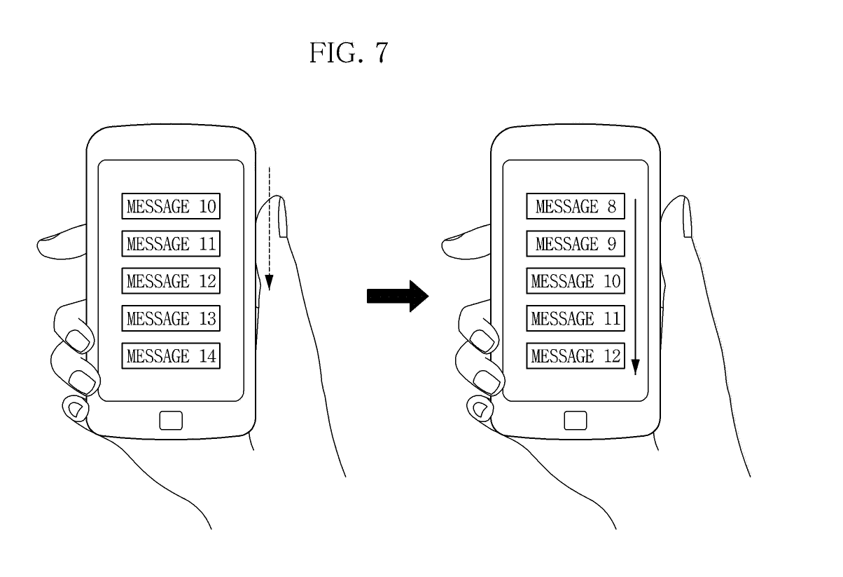

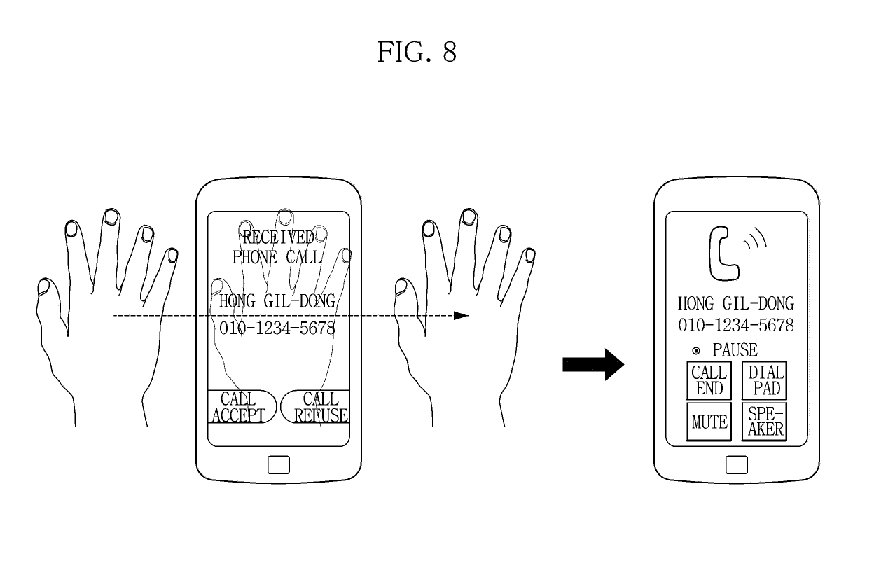

A page, a picture, a screen, a message, or the like may be switched to the next as shown in FIG. 6 by a finger motion (for example, an operation of detaching and attaching a thumb of the hand gripping the device once).

While playing a game, it may be possible to play the game by a specific finger operation (for example, an operation of detaching and attaching thumbs and index fingers of both hands gripping the device at the outer peripheral edge of the device).

The device driver 30 may recognize a drag operation through the recognition of the pattern extracted, and a reproduction section may be searched during the movie play or a volume or the like may be adjusted through the recognized drag operation.

Further, since the value of the input coordinate collected from the first recognition area in the noise mode may be less important than the input coordinate collected from the second recognition area, the device driver 30 may calculate an adjustment ratio of a search bar or a volume bar by comparing a drag distance for adjusting the search bar and the volume bar with a reference distance. For example, if the sensed drag distance is equal to or more than 5 mm, the search bar or the volume bar may be shifted by one section. If the sensed drag distance is equal to or more than 10 mm, the search bar or the volume bar may be shifted by two sections.

In addition, a movement of a character represented in the game may be controlled through the recognized drag operation.

Further, as shown in FIG. 7, the screen may be switched by scrolling in any one direction of up, down, left, and right through the recognized drag operation. For example, if the thumb of the hand gripping the device is dragged down along the right side of the device, a message list displayed on the touch panel display may be scrolled down according to the drag input.

Meanwhile, the recognition of the input pattern input through the second measurement area may be performed by recognizing an electrostatic capacitance change as the hand of the user approaches the second measurement area.

That is, the device driver 30 may recognize an operation of covering the touch screen with the hand according to the electrostatic capacitance change as the hand of the user approaches the second measurement area, and may perform switching to a mute mode or a screen stop function through the operation of covering the touch screen.

If the size of the pattern area extracted by the change in electrostatic capacitance in the second measurement area is larger than the preset size, the device driver 30 may recognize the operation of covering the touch screen with the hand.

The device driver 30 may recognize the hand motion of the user through the changed state of the pattern extracted from the second measurement area.

The device driver 30 may recognize the hand motion of the user by movement in any one direction to another direction of the input pattern generated by the electrostatic capacitance change as the hand of the user approaches the touch panel 10.

For example, if the input pattern extracted by the change in electrostatic capacitance is moved from right to left, it may be recognized that the user moves the hand from right to left. If the extracted input pattern is moved from up to down, it may be recognized that the user moves the hand from up to down.

As described above, according to the recognition of the hand motion of the user, the device driver 30 may switch the screen by scrolling the screen in any one direction of up, down, left, and right according to the recognized hand motion. Alternatively, as shown in FIG. 8, if there is a received phone call, the reception phone call connection may be accepted according to the hand motion to perform a phone call with the caller.

Accordingly, without a direct touch of the touch panel 10, the user may control the operation of the device.

Further, if the device driver 30 senses a direct touch input received by the device by recognizing a change in electrostatic capacitance generated in equipment (for example, a speaker, a camera, or the like) provided in the device, the device driver 30 may perform an operation corresponding to the equipment. A corresponding touch sensor may be arranged in proximity to each piece of the equipment.

For example, if the electrostatic capacitance of the area where the camera is installed is changed as the user touches the area where the camera is installed, it may be recognized that the user touches the camera, and the mode may be switched to a video phone call mode. If a direct contact to the speaker is sensed during the phone call, the mode may be switched to a speaker mode. If a direct contact to the speaker is sensed during a waiting mode, a volume adjustment menu may be provided.

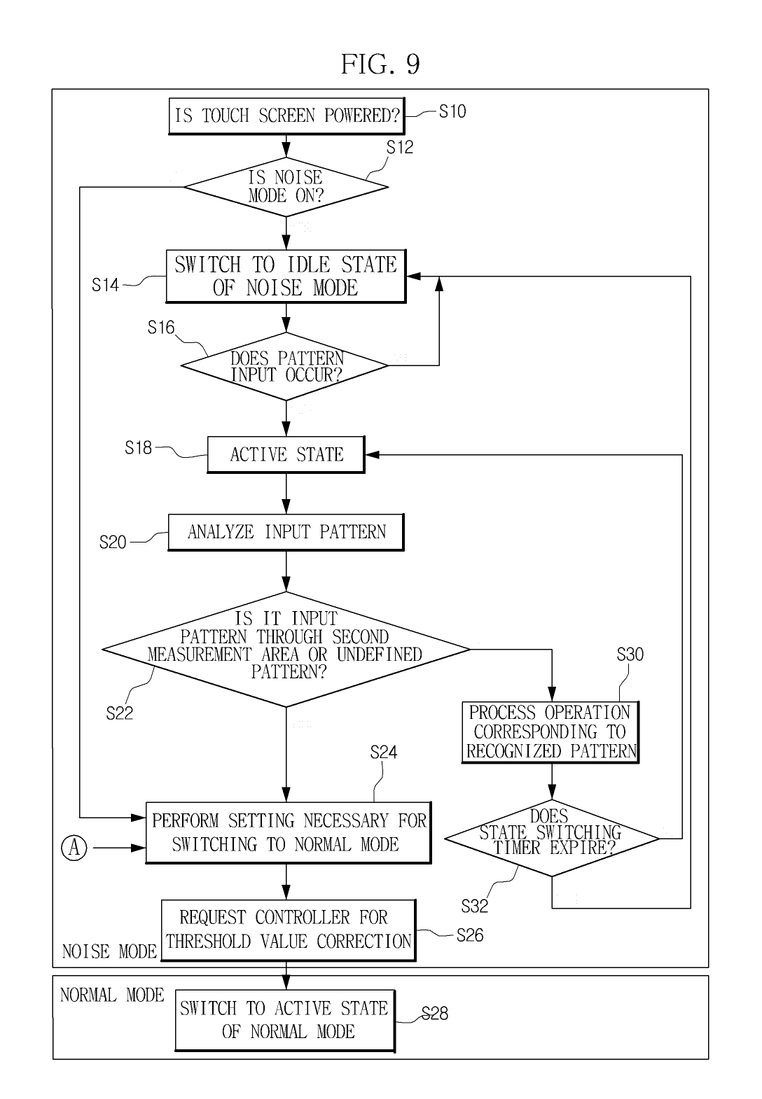

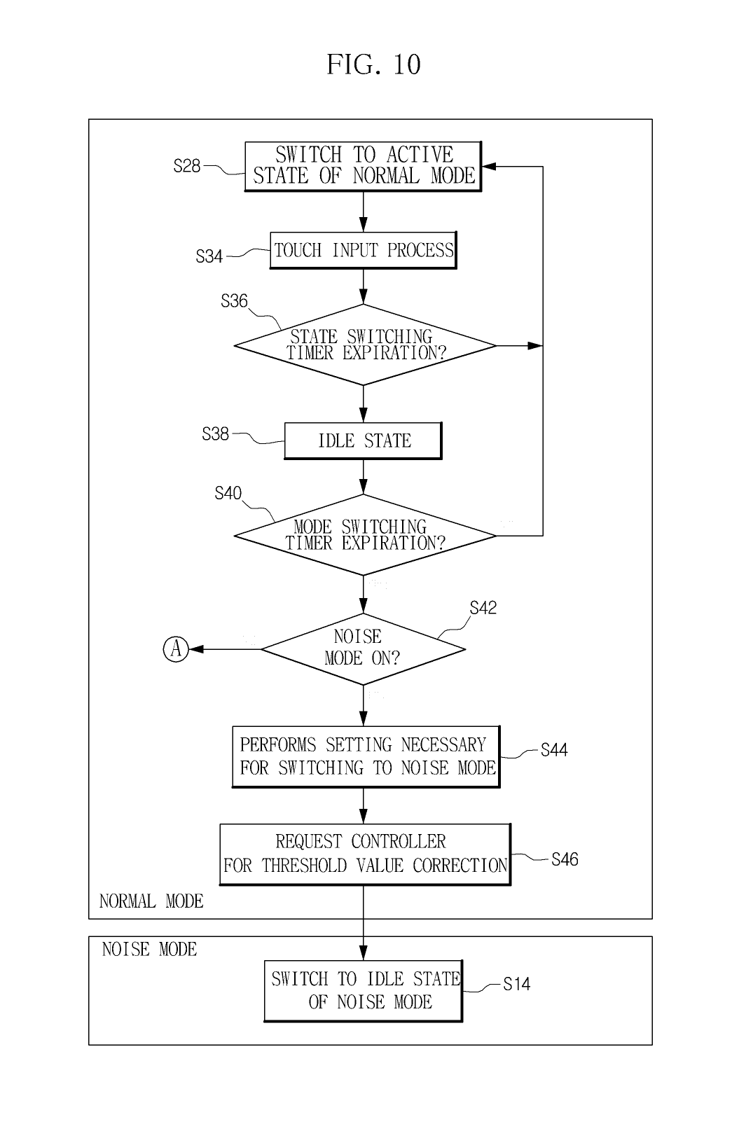

FIG. 9 and FIG. 10 are flowcharts illustrating the user interface providing method based on the touch screen according to an exemplary embodiment of the present invention.

First, as shown in FIG. 9, if the power voltage is applied to the touch screen in operation S10, the device driver 30 may initiate the noise mode set as a default setting, and confirm whether the noise mode is set to “ON” in operation S12.

In order to analyze and utilize the grip type of the user from the time when the touch screen is turned on, the noise mode may be set as a default mode.

If the noise mode is set to “ON”, the idle state of the noise mode may be initiated to reduce power consumption in operation S14.

In operation S16, the device driver 30 may determine whether the pattern input including the touch input occurs in the idle state of the noise mode.

If the pattern input does not occur as determined in operation S16, the idle state may be maintained. If the pattern input occurs, the state of the device may be changed into the active state in operation S18, and then the coordinate values applied from the touch panel 10 may be collected and the input pattern of the user may be analyzed in cooperation with the pattern recognition database 40 in operation S20.

In operation S22, it may be determined whether the input pattern of the user analyzed in the operation S20 is the input pattern input through the second measurement area as shown in FIG. 2 or an undefined pattern, e.g., the input pattern generated equal to or more than the reference threshold value for the second measurement area, or an input pattern which is not defined in the pattern recognition database 40.

If the input pattern is the input pattern input through the second measurement area or the input pattern which is not defined in the pattern recognition database 40 as determined in the operation S22, a setting for switching the operation mode to the normal mode may be performed in operation S24. Next, the controller may receive a request for adjusting a threshold value to the threshold value set in the normal mode in operation S26, and then the state may be switched to the active state of the normal mode in operation S28.

If the pattern input through the second measurement area is the input pattern generated by the direct contact in the second measurement area in the operation S22 or an undefined pattern input, the device driver 30 may determine the switching to the normal mode.

Further, even if the pattern input through the second measurement area is the input pattern generated by the electrostatic capacitance changed as the touch input provider, such as a finger or an electrostatic touch pen, approaches the second measurement area, the switching to the normal mode may be determined. Accordingly, only by the approach of the finger or the like to the second measurement area without direct touch of the user to the second measurement area, it may be possible to switch the operation mode to the normal mode.

The setting for switching to the normal mode in the operation S24 may be a setting of an area to be used in the normal mode, a setting of the threshold value to be used in the normal mode, setting of a grip and face suppression mode, and setting of the maximum number of multi-touch points to be used in the normal mode.

When switching to the active state of the normal mode in the operation S28, the state switching timer may be reset.

Meanwhile, if the input pattern is defined in the recognition database 40 as determined in the operation S22, an operation corresponding to the recognized pattern may be performed in operation S30.

Then, it may be determined whether the state switching timer expires in operation S32. If the pattern input occurs before the state switching timer expires, the active state may be maintained. When the state switching timer expires, the state switching timer may be reset and, the operation S14 may be repeated, and enter the idle state again.

Meanwhile, if the noise mode is not set to “ON” as determined in the operation S12, the process may proceed to the operation S24; the setting for switching the operation mode to the normal mode may be performed; the controller 20 may be requested for correction to the threshold value set in the normal mode; and the state may be switched to the active state of the normal mode. Thereafter, the device driver 30 operates in the normal mode.

Referring to FIG. 9 and FIG. 10, after switching to the active state of the normal mode in the operation S28, the touch input received through the active area (second measurement area) may be processed in a general touch input process in the normal mode in operation S34.

In operation S36, the device driver 30 may determine whether the state switching timer expires. If the touch input occurs through the active area (second measurement area) before the state switching timer expires, the active state may be maintained. If the state switching timer expires, the state switching timer may be reset and the state may enter the idle state in operation S38.

After entering the idle state of the normal mode in the operation S38, it may be determined whether the mode switching timer expires in operation S40. If the touch input occurs on the active area (second measurement area) before the mode switching timer expires, the process may proceed to the operation S28, and the state enter the active state again. If the mode switching timer expires, the mode switching timer may be reset, and it may be confirmed whether the noise mode is set to “ON” in operation S42.

If the noise mode is set to “ON” as determined in the operation S42, the setting for switching the operation mode to the noise mode may be performed in operation S44. In operation S46, the controller 20 may be requested for adjusting a threshold value to the threshold value set in the noise mode. Then, in operation S14, the state may be switched to the idle state of the noise mode.

The setting for switching to the noise mode in the operation S44 may be a setting of an area to be used in the noise mode, a setting of the threshold value to be used in the noise mode, a release of grip and face suppression mode setting, and a setting of the maximum multi-touch point number to be used in the noise mode.

Meanwhile, if the noise mode is not set to “ON” as determined in the operation S42, the normal mode may be maintained and the operation S24 illustrated in FIG. 9 may be repeated.

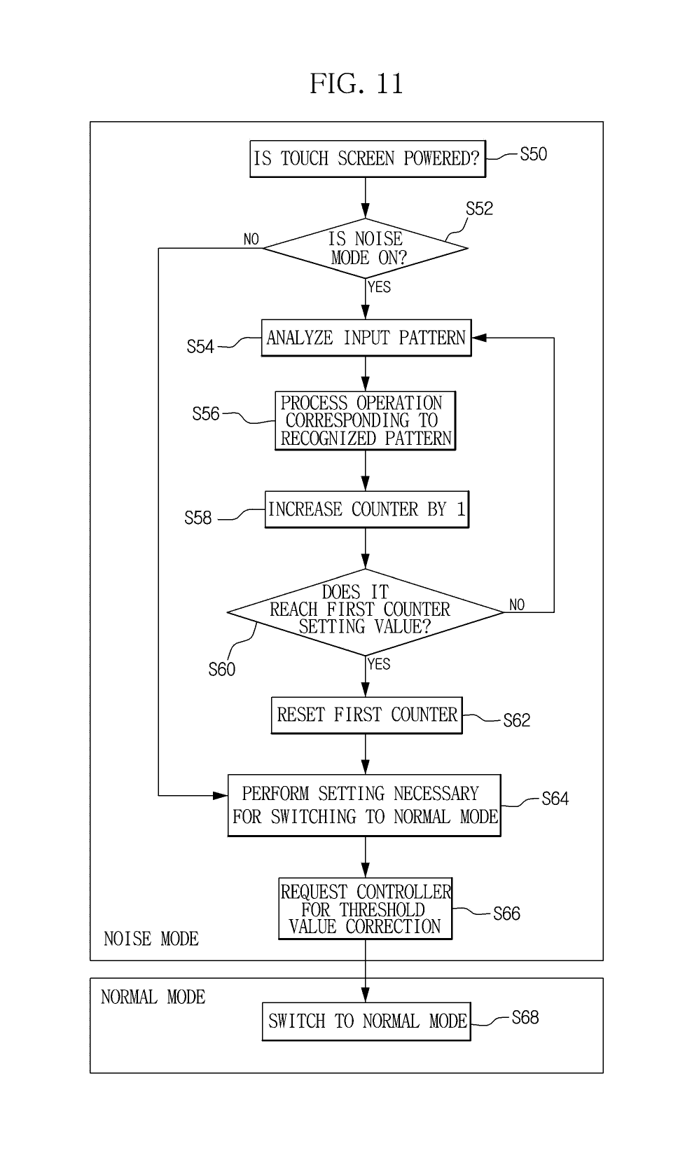

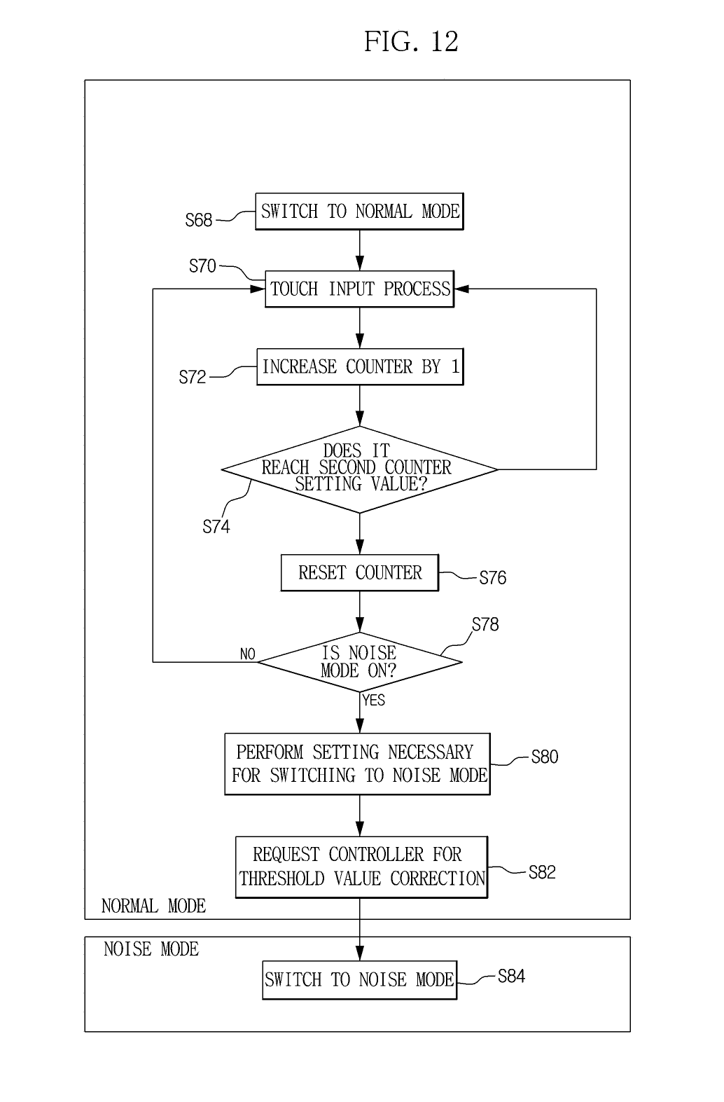

FIG. 11 and FIG. 12 are flowcharts illustrating a user interface providing method based on a touch screen according to an exemplary embodiment of the present invention.

As shown in FIG. 11, if the driving voltage or power voltage is provided to the touch screen in operation S50, the device driver 30 may enter the noise mode set as a default setting, and confirm whether the noise mode is set to “ON” in operation S52.

If the noise mode is set to “ON” as determined in the operation S52, coordinate values corresponding to touch inputs received on the touch panel 10 may be collected according to a cycle of collecting the coordinate values from the touch panel 10, and the input pattern of the user may be analyzed in cooperation with the pattern recognition database 40 in operation S54.

An operation corresponding to the pattern analyzed in the operation S54 may be performed in the operation S56, and the counter may be increased by 1 in operation S58.

In operation S60, it may be determined whether the counter value increased by 1 in the operation S58 reaches a first counter setting value. If the counter value reaches the first setting value in the operation S60, the counter value may be reset in operation S62, the device driver 30 may perform the setting for switching the operation mode to the normal mode in operation S64. In operation S66, the controller 20 may be requested for adjusting a threshold value to the threshold value set in the normal mode, and then, in operation S68, the operation mode may be switched to the normal mode.

If the noise mode is not set to “ON” as determined in the operation S52, the process may proceed to the operation S64; the setting for switching the operation mode to the normal mode may be performed; the controller 20 may be requested for adjusting a threshold value to the threshold value set in the normal mode; and then the state of the device may be switched to the active state of the normal mode. Thereafter, the device driver 30 may operate in the normal mode.

After switching to the normal mode in the operation S68, as shown in FIG. 11, and FIG. 12, the touch input may be received on the active area (e.g., the second measurement area illustrated in FIG. 2) and the coordinate values may be collected according to the cycle of collecting the coordinate values from the touch panel 10 in operation S70, and the counter may be increased by 1 in operation S72.

Thereafter, it may be determined whether the counter value increased by 1 in the operation S72 reaches the second counter setting value in operation S74. If the counter value reaches the second setting value as determined in the operation S74, the counter value may be reset in operation S76, and it may be confirmed whether the noise mode is set to “ON” in operation S78.

If the noise mode is set to “ON” as determined in the operation S78, the setting for switching the operation mode to the noise mode may be performed in operation S80; the controller 20 may be requested for adjusting a threshold value to the threshold value set in the noise mode in operation S82; and then the operation mode may be switched to the noise mode in operation S84.

If the noise mode is not set to “ON” as determined in the operation S78, the normal mode may be maintained.

As described above, if the normal mode and the noise mode are periodically switched on the basis of the counter setting value, the operation mode may be switched to the noise mode and the input pattern may be detected during the operation of the normal mode, and thus it may be possible to perform the operation corresponding to the detected input pattern, and to receive and process touch inputs of the normal mode and the noise mode.

For example, if the user grips the device with the left hand and then the hand gripping the device is changed to the right hand, it may be sensed when switching to the noise mode, and the disposition of the user interface may be switched and provided from the left hand environment to the right hand environment.

According to aspects of the present invention, it may be possible to provide the additional user interface for the user even without adding a separate sensor or the like. Accordingly, it may be possible to provide various types of user interfaces for the user.

Further, it may be possible to input a command for function performance while gripping a device with one hand.

The user interface providing apparatus and method based on the touch screen are not limited to the exemplary embodiments described above, and may be variously modified and embodied by those skilled in the art. According to aspects of the present invention, the mode switching between the normal mode and the noise mode may be performed through the mode switching timer and the pattern recognition, and the mode switching between the normal mode and the noise mode may be performed using the counter setting value. However, any of the normal mode and the noise mode may be selected by a manual input of the user, and the operation mode may be switched to the selected mode, and the operation mode may be automatically switched (for example, automatic switching from the normal mode to the noise mode) according to driving of a specific application.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus, comprising:
a touch sensing unit configured to receive a first-type touch input in a first mode, the first-type touch input being not processed in a second mode dedicated for a second-type touch input; and
a controller configured to determine whether the first mode is operated, and to process an operation in the first mode according to the first-type touch input.

2. The apparatus of claim 1, wherein the controller is configured to determine a received touch input as the first-type touch input if the received touch input has a value less than a threshold value, and to determine the received touch input as the second-type touch input if the received touch input has a value greater than or equal to the threshold value.

3. The apparatus of claim 2, wherein, in the first mode, the controller is configured to adjust the threshold value in order to enable the operation corresponding to the first-type touch input.

4. The apparatus of claim 3, wherein the threshold value is related to at least one of a value for determining a touch receivable area and a capacitive value generated by a touch input.

5. The apparatus of claim 1, further comprising:
a pattern database to store an input pattern for a first-type touch input capable of being processed in the first mode,
wherein the controller processes the operation if the received first-type touch input corresponds to an input pattern stored in the pattern database.

6. The apparatus of claim 5, wherein the controller determines a first input pattern for the first-type touch input based on a plurality of touch input recognition block, and determines whether the first input pattern corresponds to an input pattern stored in the pattern database.

7. The apparatus of claim 1, wherein the touch sensing unit comprises a first area for receiving the first-type touch input and a second area for receiving the second-type touch input, the second-type touch input being processed in the first mode or the second mode.

8. The apparatus of claim 1, wherein the controller is configured to switch between the first mode and the second mode based on at least one of a mode switching timer expiration, a recognition of a first-type touch input undefined in a pattern database, and a recognition of the second-type touch input.

9. The apparatus of claim 1, wherein the controller is configured to switch from an active state to an idle state according to a state switching timer expiration, and to switch from the idle state to the active state if the second-type touch input being processed in the second mode or an input pattern of the first-type touch input is recognized.

10. An apparatus, comprising:
a touch sensing unit comprising a first area to receive a first touch input, wherein at least a portion of the first area corresponding to an area for gripping the apparatus; and
a controller configured to determine a grip type of the apparatus according to the first touch input, and to provide a user interface based on the determined grip type.

11. The apparatus of claim 10, wherein the controller determines an input pattern for the first touch input, and determines the grip type of the apparatus according to the determined input pattern.

12. The apparatus of claim 10, wherein the grip type comprises a right-hand grip, a left-hand grip, and a two-hand grip.

13. The apparatus of claim 10, wherein the first area is activated to receive and process the first touch input in a first mode and deactivated in a second mode.

14. A method for processing a plurality of types of touch inputs, comprising:
receiving a touch input;
determining a type of the touch input from a plurality of touch input types comprising a first-type touch input and a second-type touch input; and
in response to a determination that the touch input corresponds to the first-type touch input, processing the touch input if the touch input corresponds to a defined input pattern or the touch input is received in a first mode for processing the first-type touch input.

15. The method of claim 14, wherein the first-type touch input corresponds to a noise input having a value less than a threshold value, and a second-type touch input corresponds to a normal input having a value greater than or equal to the threshold value.

16. The method of claim 15, further comprising:
adjusting the threshold value if a mode is switched from or switched to the first mode for processing the first-type touch input.

17. The method of claim 14, wherein the defined input pattern is stored in a pattern database.

18. The method of claim 14, further comprising:
in response to a determination that the touch input corresponds to the second-type touch input, processing the touch input regardless of whether the touch input corresponds to the defined input pattern or the touch input is received in the first mode for processing the first-type touch input.

19. The method of claim 14, further comprising;
switching to a second mode for disabling a processing of the first-type touch input if the touch input corresponds to a second-type touch input or the touch input corresponds to a first-type touch input having an undefined input pattern.

20. The method of claim 14, further comprising;
switching to the first mode for processing the first-type touch input based on at least one of a mode switching timer expiration and a counter setting value.
